(19) United States
(12) Patent Application Publication
(10) Pub. No.: US 2018/0357099 A1
(43) Pub. Date: Dec. 13, 2018

(54) PRE-VALIDATION OF A PLATFORM

(71) Applicant: Intel Corporation, Santa Clara, CA (US)

(72) Inventors: John J. Browne, Limerick (IE); Tomasz Kantecki, Ennis (IE); Eoin Walsh, Limerick (IE); Maryam Tahhan, Limerick (IE); Timothy Verrall, Pleasant Hill, CA (US); Tarun Viswanathan, El Dorado Hills, CA (US); Rory Browne, Limerick (IE)

(73) Assignee: Intel Corporation, Santa Clara, CA (US)

(21) Appl. No.: 15/617,375

(22) Filed: Jun. 8, 2017

(51) Int. Cl. G06F 9/50; G06F 9/48; G06F 9/455

(52) U.S. Cl. CPC G06F 9/5005; G06F 9/45504; G06F 9/4881

(57) ABSTRACT

Particular embodiments described herein provide for a network element that can be configured to determine a pre-execution performance test, where the pre-execution performance test is at least partially based on requirements for a process to be executed, cause the pre-execution performance test to be executed on a platform before the process is executed on the platform, where the platform is a dynamically allocated group of resources, analyze results of the pre-execution performance test, and cause the process to be executed on the platform if the results of the pre-execution performance test satisfy a condition. In an example, the process is a virtual network function.

### TECHNICAL FIELD

This disclosure relates in general to the field of computing and/or networking, and more particularly, to pre-validation of a platform.

### BACKGROUND

Operations of data centers are a crucial aspect of some organizational operations around the world as companies rely on their data centers to efficiently run their operations. In a data center, network management and orchestration systems are systems that provide for the arrangement and management of platforms to execute processes. The network management and orchestration system components can be configured to identify what platforms can execute a specific process. However, existing management and orchestration systems can make poor placement decisions using a limited number of host platform metrics like random access memory (RAM) size, disk size, and number of computer processing units (CPUs). These metrics are often not sufficient to verify that a platform (i.e., the environment where a process is executed) can accommodate the process and meet required service level agreements (SLAB).

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a system to enable pre-validation of a platform, in accordance with an embodiment of the present disclosure;

FIG. 2 is a simplified block diagram of a portion of a system to enable pre-validation of a platform, in accordance with an embodiment of the present disclosure;

FIG. 3 is a simplified block diagram of a table for use in a system to enable pre-validation of a platform, in accordance with an embodiment of the present disclosure;

FIG. 4 is a simplified block diagram of a table for use in a system to enable pre-validation of a platform, in accordance with an embodiment of the present disclosure;

FIG. 5 is a simplified flowchart illustrating potential operations that may be associated with the system in accordance with an embodiment;

FIG. 6 is a simplified flowchart illustrating potential operations that may be associated with the system in accordance with an embodiment; and

FIGS. 7A and 7B are a simplified flowcharts illustrating potential operations that may be associated with the system in accordance with an embodiment.

The FIGURES of the drawings are not necessarily drawn to scale, as their dimensions can be varied considerably without departing from the scope of the present disclosure.

### DETAILED DESCRIPTION

### Example Embodiments

The following detailed description sets forth example embodiments of apparatuses, methods, and systems relating to a system for enabling pre-validation of a platform. Features such as structure(s), function(s), and/or characteristic(s), for example, are described with reference to one embodiment as a matter of convenience; various embodiments may be implemented with any suitable one or more of the described features.

In the following description, various aspects of the illustrative implementations will be described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials and configurations are set forth in order to provide a thorough understanding of the illustrative implementations. However, it will be apparent to one skilled in the art that the embodiments disclosed herein may be practiced without the specific details. In other instances, well-known features are omitted or simplified to not obscure the illustrative implementations.

In the following detailed description, reference is made to the accompanying drawings that form a part hereof where like numerals designate like parts throughout, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

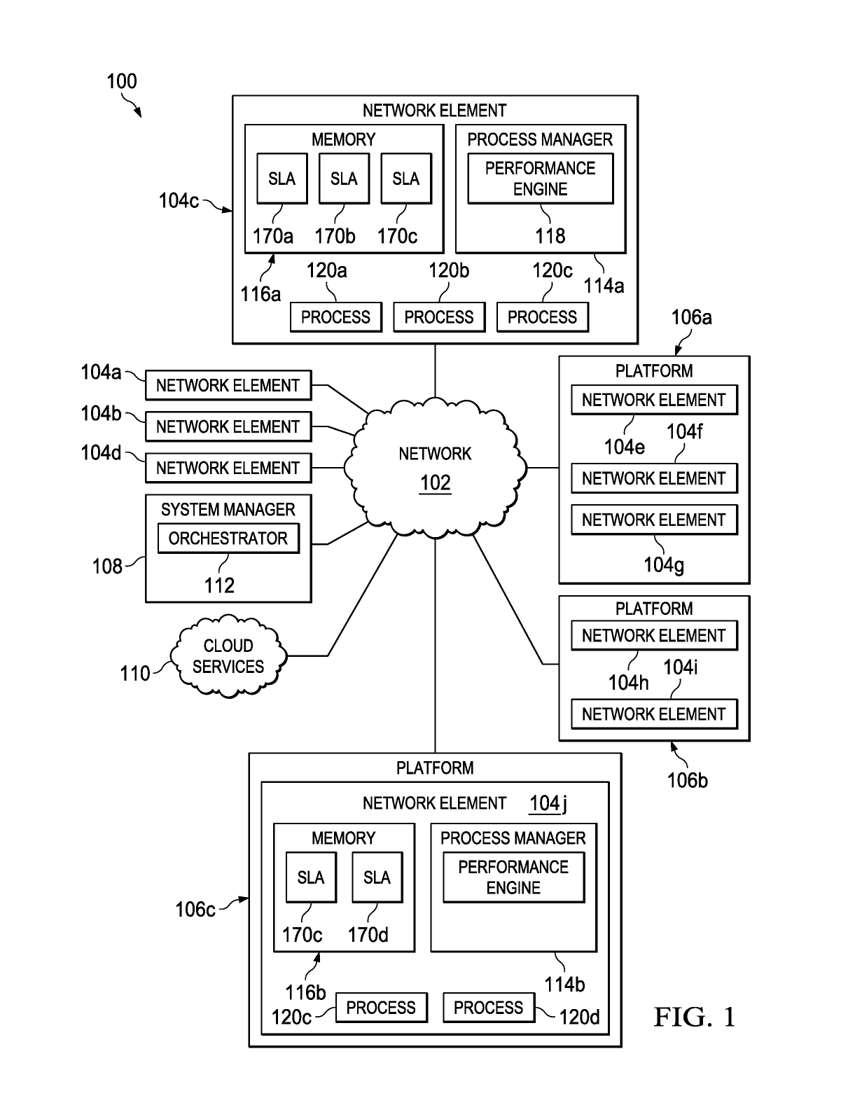

FIG. 1 is a simplified block diagram of a system 100 (e.g., data center) to enable pre-validation of a platform, in accordance with an embodiment of the present disclosure. System 100 can include one or more network elements 104a-104d, one or more platforms 106a-106c, a system manager 108, and cloud services 110. Network elements 104a-104d, platforms 106a-106c, system manager 108, and cloud services 110 can be in communication with each other using network 102.

Each of platforms 106a-106c can include one or more network elements. For example, platform 106a can include network elements 104e-104g, platform 106b can include network elements 104h and 104i, and platform 106c can include network element 104j. Each network element can include a process manager, one or more processes, and memory. For example, network element 104c includes process manager 114a, memory 116a, and processes 120a-120c. Memory 116a can include SLAs 170a-170c. Network element 104j includes process manager 114b, memory 116b, and processes 120c and 120d. Memory 116b can include SLAs 170c and 170d. Each SLA can correspond to one or more processes. For example, SLA 170a can correspond to process 120a, 120b and/or process 120c. Generally, each SLA 170a-170d is an agreement between a service provider (either internal or external) and an end user that defines the level of service expected from the service provider. In an example, each of process 120a, 120b, 120c, and/or 120d may be a network function. In a specific example, process 120a, 120b, 120c, and/or 120d may be a virtual network function (VNF). Each of process managers 114a and 114b can include a performance engine 118.

System manager 108 can include an orchestrator 112. Orchestrator 112 can be configured to group network elements into a platform that may be used during execution of processes 120a and/or 120b. In an example, system manager 108 can include a process manager similar to process managers 114a and 114b. If network 102 or a portion of network 102 is a fabric network, system manager 108 can be configured as a fabric manager.

Using performance engine 118, system 100 can be configured to determine requirements to execute a process (e.g., process 120a) and, before the process is executed on a platform (e.g., platform 106a), execute a pre-execution performance test (a stress test) on the platform to determine if the platform is able to properly execute the process and meet required SLAs. By using the pre-execution performance test before actual deployment of the process, the system can analyze the results of the pre-execution performance test and determine if the results of the pre-execution performance test satisfy a condition. For example, the system can analyze the results of the pre-execution performance test and determine if the platform is able to properly execute the process, if one or more SLAs associated with the process can be met, and if other processes, the platform, and/or network 102 will be negatively impacted by deployment of the process.

In an example, process manager 114 can be configured to determine the requirements for process 120a to be executed, determine a pre-execution performance test to execute on platforms 106a, 106b, and/or 106c to test for the requirements, cause the pre-execution performance test to be executed on platforms 106a, 106b, and/or 106c, and analyze the results to determine if process 120a can be properly executed on platforms 106a, 106b, and/or 106c. Based on the execution of the pre-execution performance test, a rating can be assigned to each of the platforms. Process 120a can then be executed on the platform with the highest rating.

The term “platform” includes an environment where a process is executed and can include a dynamically allocated group of resources. The term “process” includes an instance of a computer program, application, network function, virtual network function, etc. and can be made up of multiple threads of execution. It is to be understood that other embodiments may be utilized and structural changes may be made without departing from the scope of the present disclosure. Substantial flexibility is provided by system 100 in that any suitable arrangements and configuration may be provided without departing from the teachings of the present disclosure.

For purposes of illustrating certain example techniques of system 100, it is important to understand the communications that may be traversing the network environment. The following foundational information may be viewed as a basis from which the present disclosure may be properly explained.

A network management and orchestration system is a system that provides automated arrangement, coordination, and management of platforms, computer systems, middleware, and services and allows an administrator to supervise or manage a network's independent components inside a bigger network management framework. Typically, the network management and orchestration system can be used to monitor both software and hardware components in a network. The network management and orchestration system components can be configured to identify what devices are present on a network, monitor at the device level to determine the health of network components, and the extent to which their performance matches capacity plans and SLAs, track performance indicators such as bandwidth utilization, packet loss, latency, availability and uptime of routers, switches, and other network elements.

Existing management and orchestration systems can make poor placement decisions using a limited number of host platform metrics like random access memory (RAM) size, disk size and number of computer processing units (CPUs). These metrics are often not sufficient to verify that a platform (i.e., the environment where a process is executed) can accommodate the process and meet required SLAs, as many other processes may be deployed on the platform and dynamically consume shared resources, including cache, memory bandwidth, hard real-time timers, and dynamic I/O demands. What is needed is a system that can perform a pre-deployment platform validation test to determine if a platform can accommodate a process's requirements and meet required SLAs.

A system for pre-validation of a platform, as outlined in FIG. 1, can resolve these issues (and others). System 100 can be configured to determine if a platform can accommodate a process's requirements and meet a required SLA by using a pre-deployment platform selection process. The pre-deployment platform selection process includes a pre-execution performance test that is executed on the platform before actual deployment of the process on the platform to determine if the platform has the specific resources to execute the process. In an example, the pre-deployment platform selection process may include executing the performance test on multiple platforms, ranking or rating each platform based on the results of the performance test, and executing the process on the platform with the highest ranking or rating.

In an illustrative example, process manager 114a can be configured to determine the resources that are necessary to execute a process. Using performance engine 118, process manager 114 can use a pre-execution performance test to stress and check a platform's resources and determine if the platform satisfies a condition. The condition can include a determination of whether or not the platform has enough resources to support the execution of the process and any SLA requirements. For example, the pre-execution performance test can analyze the LLC size, memory bandwidth, memory footprint, available disks, network ports, CPU clock speed, number of CPU or cores, real-time timer latency, cache, memory bandwidth, etc. The pre-execution performance test can be executed on the platform while other processes are also executing on the platform and dynamically consuming resources. In addition, the pre-execution performance test can detect impacts on other resident processes during the test by including a synthetic workload to consume a preset amount of resources. Stressing the required resources on the platform before deployment of a process can help to remove the negative impact on service availability of deploying a process, activating the process, and subsequently discovering that the platform under performs or the process fails on the platform. Failures can be due to a preexisting hardware fault or resource contention which only appears when the process and platform are stressed.

In a specific example, the pre-execution performance test is specific to the process's resource and SLA requirements. System 100 can be configured such that the introduction of the pre-execution performance test into the deployment process does not impact the deployment time, since the pre-execution performance test can be done at any time and the results stored for later deployment decisions. In another embodiment, the pre-execution performance test can be executed in real time (e.g., at the current time), or at a pre-determined time (e.g., 3:00 AM, midnight, 12 hours from the current time, etc.). In some examples, the pre-execution performance test is already deployed on the system so there is no additional download period. The duration of the pre-execution performance test can be specified to be short (e.g., about 1 second) or long (e.g., about 1 hour) depending on the management system processes and demand.

The pre-execution performance test can be pre-loaded and not require an image to be downloaded. Also, the pre-execution performance test can support a configuration to match the required SLA of the process to be deployed, which can include required LLC size, memory bandwidth, memory footprint (RAM), disk, network ports, CPU clock speed, number of CPUs, real-time timer latency, etc. Other configurable parameters can include a pre-execution performance test start time, pre-execution performance test duration, number of errors before termination, etc. For example, the pre-execution performance tests can include a cyclic test to measure real-time timer latency, memory bandwidth test, cache utilization test, measure the number of CPU instructions per cycle, unhalted cycles, etc. In addition, the pre-execution performance test can also include a software workload test that combines CPU usage, disk, network, memory, memory bandwidth and cache utilization, etc.

After the pre-execution performance test, a report can be generated. The report can include the number of network errors, memory bandwidth, cache occupancy, instructions per cycle, network port metrics, RAM metrics, etc. Application memory bandwidth data can be determined by using memory bandwidth monitoring (MBM). Cache metrics such as application cache occupancy data can be determined by using cache monitoring technology (CMT). Misses/hits can be determined by using performance counters. CPU metrics can be determined by using standard/architectural performance counters. The number of CPU's can be taken from the operating system (OS) or a virtual machine manager (VMM). Based on the report generated, the process manager (or orchestrator 112 acting as a scheduler) can determine if the SLA for the process can be met on the platform by matching the actual results against the required SLA and also taking into account any faults that occurred during the pre-execution performance test period.

In an example, running a synthetic workload to consume a preset amount of resources on the platform can be used to determine the impact of the synthetic workload on host platform tenants and corresponding SLA's. This provides additional information about how the process will affect other applications and SLAs if a process with the same or similar parameters as the synthetic workload is deployed. Such information can augment process scheduling decisions.

Elements of FIG. 1 may be coupled to one another through one or more interfaces employing any suitable connections (wired or wireless), which provide viable pathways for network (e.g., network 102, etc.) communications. Additionally, any one or more of these elements of FIG. 1 may be combined or removed from the architecture based on particular configuration needs. System 100 may include a configuration capable of transmission control protocol/Internet protocol (TCP/IP) communications for the transmission or reception of packets in a network. System 100 may also operate in conjunction with a user datagram protocol/IP (UDP/IP) or any other suitable protocol where appropriate and based on particular needs.

Turning to the infrastructure of FIG. 1, system 100 in accordance with an example embodiment is shown. Generally, system 100 may be implemented in any type or topology of networks. Network 102 represents a series of points or nodes of interconnected communication paths for receiving and transmitting packets of information that propagate through system 100. Network 102 offers a communicative interface between nodes, and may be configured as any local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates communications in a network environment, or any suitable combination thereof, including wired and/or wireless communication. Cloud services 110 may generally be defined as the use of computing resources that are delivered as a service over a network, such as the Internet. Using cloud services 110, compute, storage, and network resources can be offered in a cloud infrastructure, effectively shifting the workload from a local network to the cloud network.

In system 100, network traffic, which is inclusive of packets, frames, signals, data, etc., can be sent and received according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP)). Additionally, radio signal communications over a cellular network may also be provided in system 100. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks. The data may help determine a status of a network element or network. The term “status” is to include the operating state of a resource, congestion of the network, data related to traffic or flow patterns of the network, or another type of data or information that helps to determine the performance, state, condition, etc. of a resource or the network, either overall or related to one or more resources. Additionally, messages, requests, responses, and queries are forms of network traffic, and therefore, may comprise packets, frames, signals, data, etc.

In an example implementation, network elements 104a-104j are meant to encompass network appliances, servers, routers, switches, gateways, bridges, load balancers, processors, modules, or any other suitable device, component, element, or object operable to exchange information in a network environment. Network elements 104a-104j may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information. Each of network elements 104a-104j may be virtual or include virtual elements.

In regards to the internal structure associated with system 100, each of network elements 104a-104j can include memory elements for storing information to be used in the operations outlined herein. Each of network elements 104a-104j may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in system 100 could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

In an example implementation, elements of system 100, such as network elements 104a-104j may include software modules (e.g., process manager 114a and 114b and performance engine 118, etc.) to achieve, or to foster, operations as outlined herein. These modules may be suitably combined in any appropriate manner, which may be based on particular configuration and/or provisioning needs. In example embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

Additionally, each of network elements 104a-104j may include a processor (or core of a processor) that can execute software or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read-only memory (EPROM), an electrically erasable programmable read-only memory (EEPROM)) or an ASIC that includes digital logic, software, code, electronic instructions, or any suitable combination thereof. Any of the potential processing elements, modules, and machines described herein should be construed as being encompassed within the broad term ‘processor.’

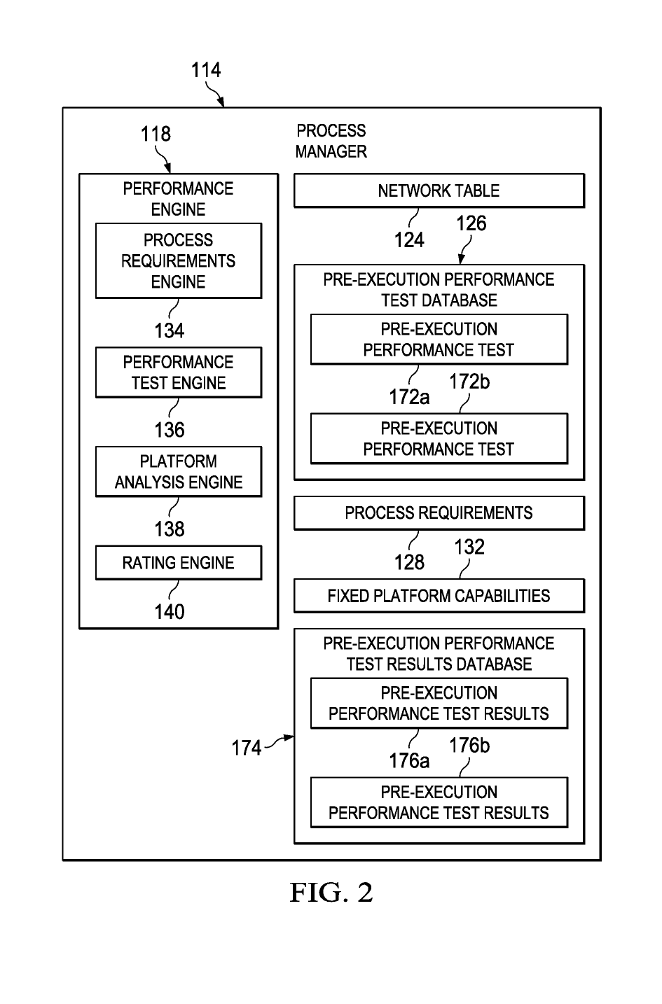

Turning to FIG. 2, FIG. 2 is a simplified block diagram of process manager 114 for use in system 100, in accordance with an embodiment of the present disclosure. As illustrated in FIG. 2, process manager 114 can include performance engine 118, a network table 124, a pre-execution performance test database 126, process requirements 128, fixed platform capabilities 132, and pre-execution performance test results database 174. In an example, network table 124, pre-execution performance test database 126, process requirements 128, fixed platform capabilities 132, and pre-execution performance test results database 174 may be stored in memory (e.g., memory 116a or 116b).

Network table 124 can include a list of available platforms and data related to each of the platforms. For example, network table 124 can include a list of network elements on a platform, the location of each of the network elements, a network name for each of the network elements, configuration of each of the network elements, specifications of each of the network elements, original equipment manufacturer (OEM) data for each of the network elements, etc. Pre-execution performance test database 126 can include one or more pre-execution performance tests 172a and 172b that may be used to stress one or more platforms. Process requirements 128 can include data related to the requirements for a specific process to execute. For example, process_A may require parameter_A, parameter_B, and parameter_C to execute. Fixed platform capabilities 132 can include data related to the capabilities, parameters, etc. of the platform that are fixed. For example, fixed platform capabilities 132 can include data related to functions such as fixed hardware accelerators for cryptography and compression, graphic processing units (GPUs), network interface card (NIC) capabilities such as inline cryptography, traffic management, classification, traffic distribution, number of ports, port speeds, etc., integrated fixed CPU capabilities such as specific instruction sets (e.g., streaming instructions, vector instructions, resource director data for cache allocation, etc.), other CPU capabilities such as CPU core counts or the number of cores in a specific CPU, turbo capabilities, number of CPUs on a platform, etc. Pre-execution performance test results database 174 can include pre-execution performance test results 176a and 176b. Pre-execution performance test results 176a and 176b are the results after a pre-execution performance test has been executed on one or more platforms. For example, pre-execution performance test results 176a can be the results after pre-execution performance test 172a has been executed on one or more platforms. Similarly, pre-execution performance test results 176b can be the results after pre-execution performance test 172b has been executed on one or more platforms. Each of pre-execution performance test results 176a and 176b can be used to make deployment decisions regarding other processes if the other processes are similar to processes 120a or 120b For example, if a new process is similar to process 120a, then pre-execution performance test results 176a can be used to determine a potential platform or platforms where the new process may be executed.

Performance engine 118 can include a process requirements engine 134, a performance test engine 136, a platform analysis engine 138, and a rating engine 140. Process requirements engine 134 can be configured to determine the requirements to execute a process (e.g., process 120a or 120b). In an example, process requirements engine 134 can access process requirements 128 in memory 116 to determine the requirements needed to execute process 120a. In another example, process requirements engine 134 can analyze process 120a and determine the requirements needed to execute process 120a. In a specific example, process requirements engine 134 can be configured to analyze the source code of process 120a to determine the requirements needed to execute process 120a. In another specific example, process requirements engine 134 can be configured to partially execute process 120a and determine the requirements needed to execute process 120a after the partial execution. More specifically, process 120a may be a services engine that initiates or triggers one or more virtual network functions. Partially executing process 120a can expose the one or more virtual network functions and allow process requirements engine 134 to analyze the one or more virtual network functions and determine the requirements needed to execute the virtual network functions. Performance test engine 136 can be configured to determine one or more pre-execution performance tests that can be executed on a platform to determine if the platform satisfies the condition of including the requirements needed to execute the process. For example, performance test engine 136 can access pre-execution performance test database 126 and use one or more pre-configured and pre-loaded performance tests (e.g., pre-execution performance test 172a or 172b) to execute on one or more platforms. In another example, performance test engine 136 can determine if a performance test has previously been executed on the one or more platforms and if it has, performance test engine 136 can obtain the results from pre-execution performance test results database 174.

Platform analysis engine 138 can be configured to analyze the results of the pre-execution performance test. In an example, platform analysis engine 138 can analyze the results of the pre-execution performance test and determine if a predetermined condition is satisfied. More specifically, the condition may be satisfied if the platform has all the required resources to execute the process. In another specific example, the condition may be satisfied if the platform includes the requirements for a process to be executed and can meet the requirements of an SLA associated with the process. In yet another specific example, rating engine 140 can assign a rating to the platform based on the results of the pre-execution performance test and if the rating is higher than a threshold, then the condition may be satisfied. In another example, if more than one platform was tested, rating engine 40 can be configured assign a rating to each platform tested and the process can be executed on the platform with the highest rating. Other criteria can be used to determine if the results of the pre-execution performance test being executed on the platform satisfies a condition.

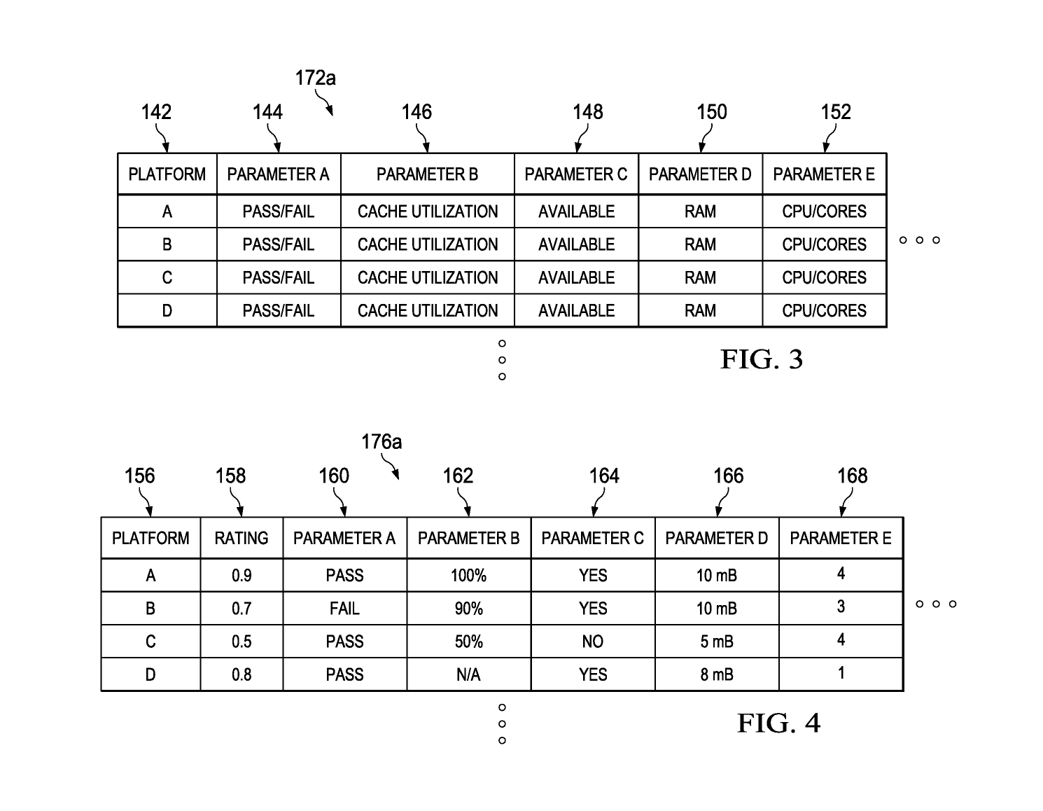

Turning to FIG. 3, FIG. 3 is a simplified block diagram of a pre-execution performance test for use in a system 100, in accordance with an embodiment of the present disclosure. As illustrated in FIG. 3, pre-execution performance test 172a can include one or more parameters that can be used to analyze a platform. The parameters can be related to resources and platform characteristics that will be need to execute a process. For example, pre-execution performance test 172a can include a platform column 142, a parameter_A column 144, a parameter_B column 146, a parameter_C column 148, a parameter_D column 150, and a parameter_E column 152. Parameter_A column 144 can include a pass/fail type of test to determine whether or not a platform conforms to specific SLA requirements, a specific component is present on the platform, the platform includes the LLC size required to execute the process, the platform has the memory bandwidth required to execute the process, the platform has the memory footprint (RAM) to execute the process, the platform has the disk or disks required to execute the process, the platform has the network ports required to execute the process, the platform has the CPU clock speed required to execute the process, etc. Parameter_B column 146 can include a test of a platform's cache utilization. Parameter_C column 148 can include a test as to whether an element or condition on the platform is available (e.g., a specific disk, a specific protocol, network path, application, device, etc.). Parameter_D column 150 can include a test as to the amount of memory or the memory footprint that may be available. Parameter_E column 152 can include a test as to the number of CPUs/cores in the platform that would be available to execute the process. In other examples, pre-execution performance test 172a can include other parameters that can be used to analyze a platform. The parameters shown in FIG. 3 are for illustration purposes and any combination of the illustrated parameters and/or other parameters that can be used to analyze a platform may be used.

Turning to FIG. 4, FIG. 4 is an example pre-execution performance test results 176a illustrating possible details that may be associated with system 100, in accordance with an embodiment. In an example, platform analysis engine 138 can analyze the results of the pre-execution performance test and rating engine 140 can assign a rating to each platform if the pre-execution performance test was executed on multiple platforms. For example, pre-execution performance test results 176a can be created after performance test engine 136 has executed pre-execution performance test 172a on multiple platforms. Pre-execution performance test results 176a can include a platform identification column 156, a rating column 158, a parameter_A results column 160, a parameter_B results column 162, a parameter_C results column 164, a parameter_D results column 166, and a parameter_E results column 168. Platform analysis engine 138 can also use pre-execution performance test results 176a to determine if a specific platform satisfies a condition (e.g., the platform includes the resources need to execute a process and can meet one or more SLAs associated with the process).

In an illustrative example, a pre-execution performance test was executed on platforms A-D. Platform A was assigned a rating of 0.9. Platform A passed the test in parameter_A, had a 100% cache utilization, the element or condition in parameter_C was available, the RAM size was 10 mb, and the CPU/cores available was 4. In contrast, platform C was assigned a rating of 0.5. Platform C passed the test in parameter_A, had a 50% cache utilization, the element or condition in parameter_C was not available, the RAM size was 5 mb, and the CPU/cores available was 4. In other examples, pre-execution performance test 172a and/or pre-execution performance test results 176a may include other types of indicators other than pass/fail or a percentage to indicate the level or operating status of an element in the platform that may be used during the execution of the process. For example, other indicators may be related to resource load or overload, core resource available compute capacity, the fill or load of a buffer or memory, amount of traffic through a resource, a thermal status check, core/CPU temperature, cooling fan speed, electro-mechanical/core characteristics, core resource available compute capacity, etc.

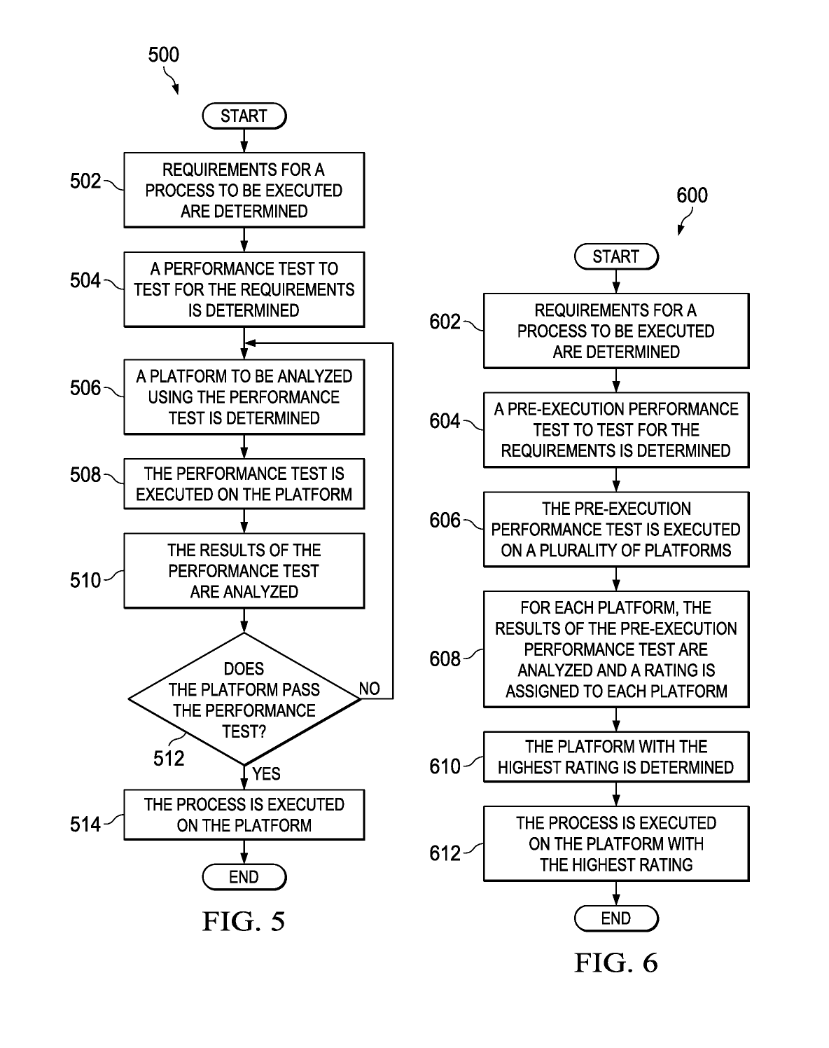

Turning to FIG. 5, FIG. 5 is an example flowchart illustrating possible operations of a flow 500 that may be associated with pre-validation of a platform, in accordance with an embodiment. In an embodiment, one or more operations of flow 500 may be performed by performance engine 118. At 502, requirements for a process to be executed are determined. For example, the requirements for the process to be executed can include a requirement to satisfy an SLA associated with the process. At 504, a performance test (e.g., pre-execution performance test 172a) to test for the requirements is determined. At 506, a platform to be analyzed using the performance test is determined. For example, platform 106a, 106b, or 106c or network elements 104a, 104b, and 104d (where network element 104a, 104b, and 104d make up a platform that can execute process 120a) may be analyzed using the performance test. At 508, the performance test is executed on the platform. The performance test can be executed on the platform while other processes are also executing on the platform and dynamically consuming resources. At 510, the results of the performance test are analyzed. At 512, it is determined if the platform passes the performance test (e.g., satisfies a condition). For example, if the platform includes the requirements for a process to be executed and can meet the requirements of an SLA associated with the process, then the platform satisfies a condition and passes the performance test. In another example, rating engine 140 can assign a rating to the platform based on the results of the pre-execution performance test and if the rating satisfies a condition of being higher than a threshold, then the platform passes the performance test. If the platform did not pass the performance test, then the process returns to 506 and a (new) platform to be analyzed using the performance test is determined. If the platform did pass the performance test, then the process is executed on the platform, as in 514.

Turning to FIG. 6, FIG. 6 is an example flowchart illustrating possible operations of a flow 600 that may be associated with pre-validation of a platform, in accordance with an embodiment. In an embodiment, one or more operations of flow 600 may be performed by performance engine 118. At 602, requirements for a process to be executed are determined. For example, process requirements engine 134 can determine the requirements to execute process 120a using process requirements 128 in memory 116 or process requirements engine 134 can analyze process 120a and determine the necessary requirements to execute process 120a. At 604, a pre-execution performance test to test for the requirements is determined. For example, performance test engine 136 can determine the pre-execution performance test that can be executed on a platform (e.g., platform 106a) using pre-execution performance test database 126 in memory 116 or performance test engine 136 can analyze the determined requirements to execute process 120a and create a pre-execution performance test. At 606, the pre-execution performance test is executed on a plurality of platforms. For example, the pre-execution performance test may be executed on platform 106a and 106c as well as network elements 104a and 104b (where network elements 104a and 104b make up a platform that can execute process 120a). The pre-execution performance test can be executed on each platform while other processes are also executing on the platforms and dynamically consuming resources. At 608, for each platform, the results of the pre-execution performance test are analyzed and a rating is assigned to each platform. For example, rating engine 140 can analyze the results of the pre-execution performance test and create a table similar to pre-execution performance test results 176a illustrated in FIG. 4. At 610, the platform with the highest rating is determined. At 612, the process is executed on the platform with the highest rating.

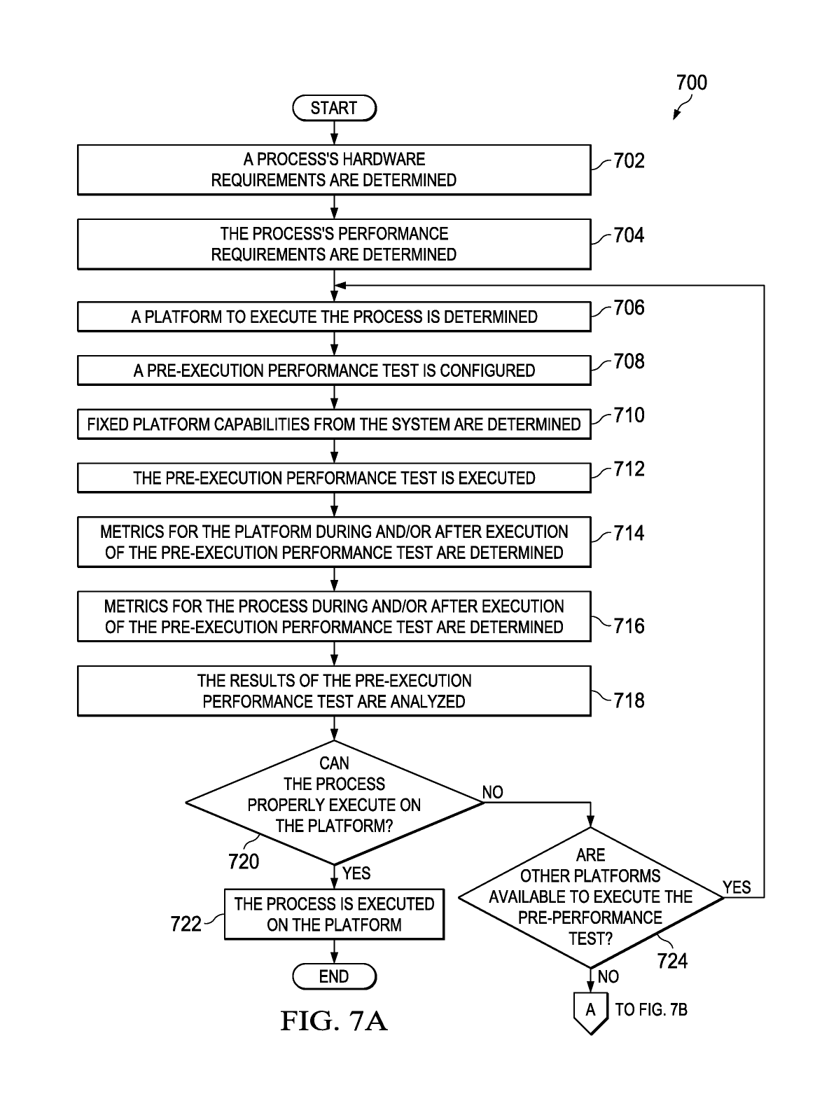

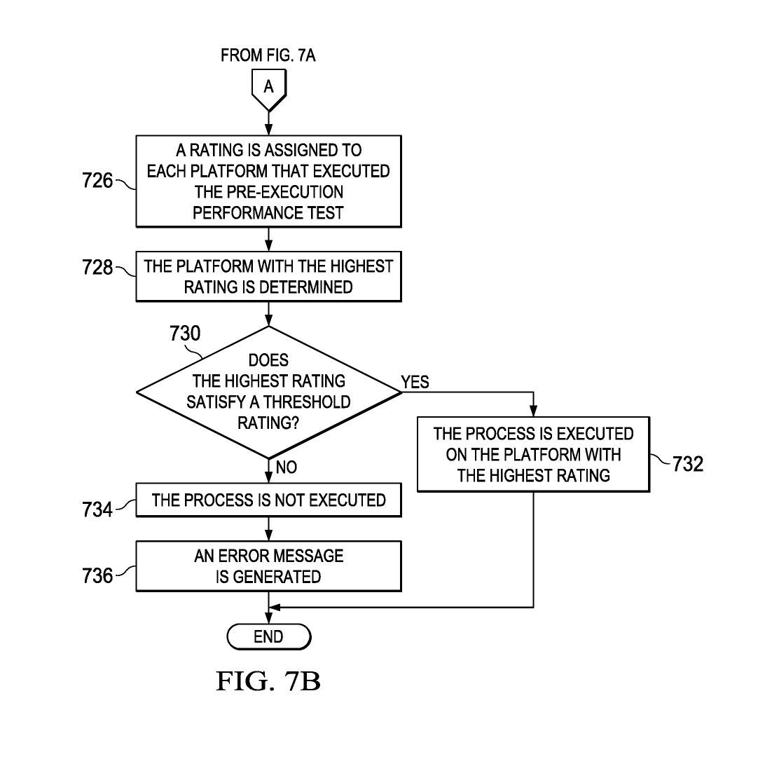

Turning to FIGS. 7A and 7B, FIGS. 7A and 7B are example flowcharts illustrating possible operations of a flow 700 that may be associated with pre-validation of a platform, in accordance with an embodiment. In an embodiment, one or more operations of flow 700 may be performed by performance engine 118. At 702, a process's hardware requirements are determined. For example, process requirements engine 134 can be configured to determine the hardware requirements for the proper execution of process 120a using process requirements 128. In another example, process requirements engine 134 can analyze process 120a and determine the necessary hardware requirements for the proper execution of process 120a. At 704, the process's performance requirements are determined. For example, process requirements engine 134 can be configured to determine the performance requirements for the proper execution of process 120a using process requirements 128. In another example, process requirements engine 134 can analyze process 120a and determine the necessary performance requirements for the proper execution of process 120a. At 706, a platform to execute the process is determined. At 708, a pre-execution performance test is configured. At 710, fixed platform capabilities from the system are determined. For example, using fixed platform capabilities 132, process manager 114 can determined the fixed capabilities of the platform that will execute the pre-execution performance test. Knowing the fixed capabilities of the platform can help analyze the results of the pre-execution performance test and can help determine if the process can be successfully executed on the platform. At 712, the pre-execution performance test is executed. For example, performance test engine 136 can execute the pre-execution performance test. At 714, metrics for the platform during and/or after execution of the pre-execution performance test are determined. For example, platform analysis engine 138 can be configured to determine metrics for the platform during and/or after execution of the pre-execution performance test. At 716, metrics for the process during and/or after execution of the pre-execution performance test are determined. For example, platform analysis engine 138 can be configured to determine metrics for the process during and/or after execution of the pre-execution performance test. The metrics for the platform and the network are important for timely transport of data through aggregated network elements such as gateways and switches. For packet processing workloads (e.g., telecommunications workloads in 3G/4G, broadband, WiFi, etc.), the metrics can include throughput in both upstream and downstream directions, packet delay variation or jitter, packets dropped, CPU/core utilization, etc. For real-time workloads (e.g., 3G/4G base stations, radio network controllers, etc.), the metrics can include a timing deadline requirement, number of times the timing deadline requirement was missed, etc. At 718, the results of the pre-execution performance test are analyzed.

At 720, it is determined if the process can properly execute on the platform. If the process can properly execute on the platform, then the process is executed on the platform, as in 722. If the process cannot properly execute on the platform, then it is determined if other platforms are available to execute the pre-execution performance test, as in 724. If other platforms are available to execute the pre-execution performance test, then a (new) platform to execute the process is determined, as in 706. If there are not any other platforms available to execute the pre-execution performance test, then a rating is assigned to each platform that executed the pre-execution performance test, as in 726. For example, rating engine 140 can assign a rating similar to the rating illustrated in FIG. 4 for each platform that executed the pre-execution performance test. At 728, the platform with the highest rating is determined. At 730, it is determined if the highest rating satisfies a threshold rating. If the rating does satisfy a threshold rating, then the process is executed on the platform with the highest rating, as in 732. If the rating does not satisfy the threshold rating, then the process is not executed, as in 734. At 736, an error message is generated.

Note that with the examples provided herein, interaction may be described in terms of two, three, or more network elements. However, this has been completion for purposes of clarity and example only. In certain cases, it may be easier to describe one or more of the functionalities of a given set of flows by only referencing a limited number of network elements. It should be appreciated that system 100 and their teachings are readily scalable and can accommodate a large number of components, as well as more complicated/sophisticated arrangements and configurations. Accordingly, the examples provided should not limit the scope or inhibit the broad teachings of system 100 as potentially applied to a myriad of other architectures.

It is also important to note that the operations in the preceding flow diagrams (i.e., FIGS. 5-7B) illustrate only some of the possible correlating scenarios and patterns that may be executed by, or within, system 100. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by system 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although system 100 have been illustrated with reference to particular elements and operations that facilitate the communication process, these elements and operations may be replaced by any suitable architecture, protocols, and/or processes that achieve the intended functionality of system 100.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### Other Notes and Examples

Example C1 is at least one machine readable storage medium having one or more instructions that when executed by at least one processor, cause the at least one processor to determine a pre-execution performance test, where the pre-execution performance test is at least partially based on requirements for a process to be executed, cause the pre-execution performance test to be executed on a platform before the process is executed on the platform, where the platform is a dynamically allocated group of resources, analyze results of the pre-execution performance test, and cause the process to be executed on the platform if the results of the pre-execution performance test satisfy a condition.

In Example C2, the subject matter of Example C1 can optionally include where the one or more instructions, when executed by the at least one processor, further cause the at least one processor to cause to be executed on each of a plurality of platforms, and assign a rating to each of the plurality of platforms, where the rating for each platform is based on the results of the pre-execution performance test being executed on the plurality of platforms.

In Example C3, the subject matter of any one of Examples C1-C2 can optionally include where the one or more instructions, when executed by the at least one processor, further cause the at least one processor to determine a platform with a highest rating, and cause the process to be executed on the platform with the highest rating.

In Example C4, the subject matter of any one of Examples C1-C3 can optionally include where the condition includes the platform complying with a service level agreement related to the process.

In Example C5, the subject matter of any one of Examples C1-C4 can optionally include where the process is a virtual network function.

In Example C6, the subject matter of any one of Examples C1-C5 can optionally include where a plurality of devices in the platform are virtual machines.

In Example C7, the subject matter of any one of Examples C1-C6 can optionally include where the results of the pre-execution performance test are analyzed to create a pre-execution performance test results table.

In Example C8, the subject matter of any one of Examples C1-C7 can optionally include where the pre-execution performance test is executed on the platform while other processes are also executing and dynamically consuming resources on the platform.

In Example C9, the subject matter of any one of Examples C1-C8 can optionally include where results table the pre-execution performance test is stored in local memory.

In Example A1, an apparatus can include memory, a performance engine, and at least one processor. The performance engine can be configured to cause the at least one processor to determine a pre-execution performance test, where the pre-execution performance test is at least partially based on requirements for a process to be executed, cause the pre-execution performance test to be executed on a platform before the process is executed on the platform, where the platform is a dynamically allocated group of resources, analyze results of the pre-execution performance test, and cause the process to be executed on the platform if the results of the pre-execution performance test satisfy a condition.

In Example, A2, the subject matter of Example A1 can optionally include where the performance engine is further configured to cause at least one processor to cause the pre-execution performance test to be executed on each of a plurality of platforms, and assign a rating to each of the plurality of platforms, where the rating for each platform is based on the results of the pre-execution performance test being executed on the plurality of platforms.

In Example A3, the subject matter of any one of Examples A1-A2 can optionally include where the at least one processor is further configured to cause the performance engine to determine a platform with a highest rating and cause the process to be executed on the platform with the highest rating.

In Example A4, the subject matter of any one of Examples A1-A3 can optionally include where the condition includes the platform complying with a service level agreement related to the process.

In Example A5, the subject matter of any one of Examples A1-A4 can optionally include where the process is a virtual network function.

Example M1 is a method including determining a pre-execution performance test, where the pre-execution performance test is at least partially based on requirements for a process to be executed, causing the pre-execution performance test to be executed on a platform before the process is executed on the platform, where the platform is a dynamically allocated group of resources, analyzing results of the pre-execution performance test, and causing the process to be executed on the platform if the results of the pre-execution performance test satisfy a condition.

In Example M2, the subject matter of Example M1 can optionally include causing the pre-execution performance test to be executed on a plurality of platforms and assigning a rating to each of the plurality of platforms, where the rating for each platform is based on the results of the pre-execution performance test being executed on the plurality of platforms.

In Example M3, the subject matter of any one of the Examples M1-M2 can optionally include determining a platform with a highest rating and causing the process to be executed on the platform with the highest rating.

In Example M4, the subject matter of any one of the Examples M1-M3 can optionally include where the condition includes the platform complying with a service level agreement related to the process.

In Example M5, the subject matter of any one of the Examples M1-M4 can optionally include where a plurality of devices in the platform are virtual machines.

In Example M6, the subject matter of any one of Examples M1-M5 can optionally include where the process is a virtual network function.

Example S1 is a platform for pre-validation of a platform, the platform can include memory, one or more processors, and a performance engine located in a network element. The performance engine can be configured to determine a pre-execution performance test, where the pre-execution performance test is at least partially based on requirements for a process to be executed, cause the pre-execution performance test to be executed on a platform before the process is executed on the platform, where the platform is a dynamically allocated group of resources, analyze results of the pre-execution performance test, and cause the process to be executed on the platform if the results of the pre-execution performance test satisfy a condition.

In Example S2, the subject matter of Example S1 can optionally include where the performance engine is further configured to cause the pre-execution performance test to be executed on a plurality of platforms and assign a rating to each of the plurality of platforms, where the rating is based on the results of the pre-execution performance test being executed on the plurality of platforms.

In Example S3, the subject matter of any one of the Examples S1-S2 can optionally include where the performance engine is further configured to determine a platform with a highest rating and cause the process to be executed on the platform with the highest rating.

In Example S4, the subject matter of any one of the Examples S1-S3 can optionally include where the condition includes the platform complying with a service level agreement related to the process.

In Example S5, the subject matter of any one of the Examples S1-S4 can optionally include where the process is a virtual network function.

In Example S6, the subject matter of any one of the Examples S1-S5 can optionally include where a plurality of devices in the platform are virtual machines.

In Example S7, the subject matter of any one of the Examples S1-S6 can optionally include where the pre-execution performance test is stored in local memory.

Example AA1 is a device including, memory, one or more processor, means for determining a pre-execution performance test, where the pre-execution performance test is at least partially based on requirements for a process to be executed, means for causing the pre-execution performance test to be executed on a platform before the process is executed on the platform, where the platform is a dynamically allocated group of resources, means for analyzing results of the pre-execution performance test, and means for causing the process to be executed on the platform if the results of the pre-execution performance test satisfy a condition.

In Example AA2, the subject matter of Example AA1 can optionally include means for causing the pre-execution performance test to be executed on each of a plurality of platforms and means for assigning a rating to each of the plurality of platforms, where the rating for each platform is based on the results of the pre-execution performance test being executed on the plurality of platforms.

In Example AA3, the subject matter of any one of Examples AA1-AA2 can optionally include means for determining a platform with a highest rating, and means for causing the process to be executed on the platform with the highest rating.

In Example AA4, the subject matter of any one of Examples AA1-AA3 can optionally include where the condition includes the platform complying with a service level agreement related to the process.

In Example AA5, the subject matter of any one of Examples AA1-AA4 can optionally include the process is a virtual network function.

In Example AA6, the subject matter of any one of Examples AA1-AA5 can optionally include where a plurality of devices in the platform are virtual machines.

In Example AA7, the subject matter of any one of Examples AA1-AA6 can optionally include where the results of the pre-execution performance test are analyzed to create a pre-execution performance test results table.

In Example AA8, the subject matter of any one of Examples AA1-AA7 can optionally include where the pre-execution performance test is executed on the platform while other processes are also executing and dynamically consuming resources on the platform.

In Example AA9, the subject matter of any one of Examples AA1-AA8 can optionally include where the pre-execution performance test is stored in local memory.

Example X1 is a machine-readable storage medium including machine-readable instructions to implement a method or realize an apparatus as in any one of the Examples A1-A9 or M1-M6. Example Y1 is an apparatus comprising means for performing of any of the Example methods M1-M6. In Example Y2, the subject matter of Example Y1 can optionally include the means for performing the method comprising a processor and a memory. In Example Y3, the subject matter of Example Y2 can optionally include the memory comprising machine-readable instructions.

What is claimed is:

1. At least one machine readable medium comprising one or more instructions that, when executed by at least one processor, cause the at least one processor to:
determine a pre-execution performance test, wherein the pre-execution performance test is at least partially based on requirements for a process to be executed;
cause the pre-execution performance test to be executed on a platform before the process is executed on the platform, wherein the platform is a dynamically allocated group of resources;
analyze results of the pre-execution performance test; and
cause the process to be executed on the platform if the results of the pre-execution performance test satisfy a condition.

2. The at least one machine readable medium of claim 1, wherein the one or more instructions, when executed by the at least one processor, further cause the at least one processor to:
cause the pre-execution performance test to be executed on each of a plurality of platforms; and
assign a rating to each of the plurality of platforms, wherein the rating for each platform is based on the results of the pre-execution performance test being executed on the plurality of platforms.

3. The at least one machine readable medium of claim 2, wherein the one or more instructions, when executed by the at least one processor, further cause the at least one processor to:
determine a platform with a highest rating; and
cause the process to be executed on the platform with the highest rating.

4. The at least one machine readable medium of claim 1, wherein the condition includes the platform complying with a service level agreement related to the process.

5. The at least one machine readable medium of claim 1, wherein the process is a virtual network function.

6. The at least one machine readable medium of claim 1, wherein a plurality of devices in the platform are virtual machines.

7. The at least one machine readable medium of claim 1, wherein the results of the pre-execution performance test are analyzed to create a pre-execution performance test results table.

8. The at least one machine readable medium of claim 1, wherein the pre-execution performance test is executed on the platform while other processes are also executing and dynamically consuming resources on the platform.

9. An apparatus comprising:
memory;
a performance engine; and
at least one processor, wherein the performance engine is configured to cause the at least one processor to:
determine a pre-execution performance test, wherein the pre-execution performance test is at least partially based on requirements for a process to be executed;
cause the pre-execution performance test to be executed on a platform before the process is executed on the platform, wherein the platform is a dynamically allocated group of resources;
analyze results of the pre-execution performance test; and
cause the process to be executed on the platform if the results of the pre-execution performance test satisfy a condition.

10. The apparatus of claim 9, wherein the performance engine is further configured to cause the at least one processor to:
cause the pre-execution performance test to be executed on each of a plurality of platforms; and
assign a rating to each of the plurality of platforms, wherein the rating for each platform is based on the results of the pre-execution performance test being executed on the plurality of platforms.

11. The apparatus of claim 10, wherein the performance engine is further configured to cause the at least one processor to:
determine a platform with a highest rating; and
cause the process to be executed on the platform with the highest rating.

12. The apparatus of claim 9, wherein the condition includes the platform complying with a service level agreement related to the process.

13. The apparatus of claim 9, wherein the process is a virtual network function.

14. A method comprising:
determining a pre-execution performance test, wherein the pre-execution performance test is at least partially based on requirements for a process to be executed;
causing the pre-execution performance test to be executed on a platform before the process is executed on the platform, wherein the platform is a dynamically allocated group of resources;
analyzing results of the pre-execution performance test; and
causing the process to be executed on the platform if the results of the pre-execution performance test satisfy a condition.

15. The method of claim 14, further comprising:
causing the pre-execution performance test to be executed on a plurality of platforms; and
assigning a rating to each of the plurality of platforms, wherein the rating for each platform is based on the results of the pre-execution performance test being executed on the plurality of platforms.

16. The method of claim 15, further comprising:
determining a platform with a highest rating; and
causing the process to be executed on the platform with the highest rating.

17. The method of claim 14, wherein the condition includes the platform complying with a service level agreement related to the process.

18. The method of claim 14, wherein a plurality of devices in the platform are virtual machines.

19. The method of claim 14, wherein the process is a virtual network function.

20. A system for pre-validation of a platform, the system comprising:
memory;
one or more processors;
means for determining a pre-execution performance test, wherein the pre-execution performance test is at least partially based on requirements for a process to be executed;
means for causing the pre-execution performance test to be executed on a platform before the process is executed on the platform, wherein the platform is a dynamically allocated group of resources;
means for analyzing results of the pre-execution performance test; and
means for causing the process to be executed on the platform if the results of the pre-execution performance test satisfy a condition.

21. The system of claim 20, further comprising:
means for causing the pre-execution performance test to be executed on a plurality of platforms; and
means for assigning a rating to each of the plurality of platforms, wherein the rating is based on the results of the pre-execution performance test being executed on the plurality of platforms.

22. The system of claim 21, further comprising:
means for determining a platform with a highest rating; and
means for causing the process to be executed on the platform with the highest rating.

23. The system of claim 20, wherein the condition includes the platform complying with a service level agreement related to the process.

24. The system of claim 20, wherein the process is a virtual network function.

25. The system of claim 20, wherein a plurality of devices in the platform are virtual machines.
